(19) United States
(12) Patent Application Publication
(10) Pub. No.: US 2013/0101094 A1
(43) Pub. Date: Apr. 25, 2013

(54) METHOD FOR TESTING A COMPONENT OF A VECTORING SYSTEM AND LINE TERMINATION EQUIPMENT CONFIGURED TO CARRY OUT SAID METHOD

(71) Applicants: Michael Peeters, Lint (BE); Jochen Maes, Veerle (BE)

(72) Inventors: Michael Peeters, Lint (BE); Jochen Maes, Veerle (BE)

(73) Assignee: ALCATEL LUCENT, Paris (FR)

(21) Appl. No.: 13/695,750

(22) PCT Filed: May 10, 2011
(86) PCT No.: PCT/EP2011/057496

§ 371 Date: Dec. 27, 2012

(30) Foreign Application Priority Data
May 18, 2010 (EP) 10305527.3

(51) Int. Cl. H04B 3/32

(52) U.S. Cl. CPC H04B 3/32
USPC 379/28

(57) ABSTRACT

The invention pertains to a method and apparatus for testing a component of a vectoring system, such as a DSLAM performing crosstalk cancellation. The method is based on the insight that line termination equipment, such as a DSLAM, and in particular the crosstalk canceller, can be used to simulate a multiline network. A signal is exchanged between the line termination equipment and attached network termination equipment, passing through the crosstalk canceller which acts as a multiline simulator. Information indicative of an error component in a received version of the signal is used to assess the operation the vectoring system.

### FIELD OF INVENTION

The present invention relates to line termination equipment such as digital subscriber line access multiplexers (DSLAMs) adapted to apply vectoring. In particular, the present invention relates to a method to test certain functions of vectoring systems comprising such line termination equipment. The testing may inter alia pertain to the DSLAM, Customer Premises Equipment (CPEs), or interoperability between such DSLAMs and such CPEs.

### BACKGROUND

Electronic wireline simulators have been developed to allow testing of wireline transmission equipment without having to resort to a “cable farm”, i.e. a large collection of different types and lengths of cable over which the transmission capabilities can be tested. The known wireline simulators synthesize a circuit presenting a certain attenuation and phase distortion to the signals applied to it. In this way, a known wireline simulator adequately simulates a single piece of cable, the simulated length and type of which may be varied within a predetermined range. The known wireline simulators do not allow the simulation of crosstalk between multiple lines.

Modern digital subscriber line equipment, in particular ADSL and VDSL equipment, has the capability to perform “vectoring”, i.e. to coordinate the signals transmitted on different lines using a crosstalk canceller, in such a way that the crosstalk between the different lines is substantially cancelled out by the signal components added to each original signal by the crosstalk canceller. To adequately and efficiently test a system comprising a digital subscriber line access multiplexer (DSLAM) with vectoring capabilities, it is desired to have the equivalent of a wireline simulator, with the ability to simulate multiple mutually coupled lines.

### SUMMARY

It is an object of the present invention to overcome the above mentioned shortcomings of the known wireline simulators.

According to a first aspect of the present invention, there is provided a method for testing a component of a vectoring system, the vectoring system comprising line termination equipment having a crosstalk canceller and network termination equipment attached to the line termination equipment, the method comprising: configuring the crosstalk canceller with a first set of crosstalk canceller parameters representing a simulated network, exchanging a first signal between the line termination equipment and the network termination equipment, the first signal being coded by the crosstalk canceller, obtaining at the line termination equipment information indicative of an error component in a received version of the first signal, and using the information to assess the operation of the component in the simulated network.

It is an advantage of the method of the present invention that the function of a coupled multiline wireline simulator can be provided without using additional equipment, i.e. by using the line termination equipment itself as a wireline simulator operating completely in the digital domain. The terms “line termination equipment” and “line termination apparatus”, as used in this application, are understood to designate inter alia a DSLAM, whether in a stand-alone, rack-based, cabinet-based or any other configuration, or a line card or set of commonly controlled line cards of such a DSLAM. When the term DSLAM is used, this is done without loss of generality, unless stated otherwise.

This goal can advantageously be achieved by initially programming the crosstalk canceller with a set of parameters that represents a set of lines with a certain degree of mutual crosstalk coupling, and, optionally, certain attenuation and/or phase distortion characteristics. Any signal transmitted (or received) by the line termination equipment will, on passing through the crosstalk canceller, undergo the same transformation as would be observed if the signal were to pass to the corresponding wireline network. By analyzing an error component on the received version of the code signal, it is possible to determine if the vectoring functions of a system component such as the DSLAM, more particularly its crosstalk canceller, or the CPE, or the overall system comprising DSLAM and CPE, operate correctly.

In an embodiment of the method of the present invention, the using of the information comprises determining at the line termination equipment a second set of crosstalk canceller parameters in function of the information, and verifying whether the second set of crosstalk canceller parameters substantially cancels the first set of crosstalk canceller parameters.

If the vectoring functions of the DSLAM, of the CPE or of the overall system comprising DSLAM and CPE, operate correctly, the verification step will reveal that the calculated crosstalk canceller parameters are capable of cancelling out the crosstalk that was artificially introduced by the first set of parameters. This second step can additionally be tested in situ.

In an embodiment of the method of the present invention, the verifying comprises obtaining the second set of crosstalk canceller parameters from the line termination equipment, and ascertaining whether the second set of crosstalk canceller parameters is substantially a matrix-inverse of the first set of crosstalk canceller parameters.

It is an advantage of this embodiment that the verification step can be performed off-line, after a large number of tests have been conducted.

In an embodiment of the method of the present invention, the verifying comprises: calculating a third set of crosstalk canceller parameters as a function of the first set of crosstalk canceller parameters and the second set of crosstalk canceller parameters; reconfiguring the crosstalk canceller with the third set of crosstalk canceller parameters; exchanging a second signal between the line termination equipment and the network termination equipment, the second signal being coded by said crosstalk canceller; and detecting an error component of the coded second signal.

It is an advantage of this embodiment that the verification can be carried out by using appropriate standardized customer premises equipment to terminate the lines under test. Such customer premises equipment is normally capable of measuring an error component in pilot signals transmitted by the DSLAM to configure the vectoring control entity. Such customer premises equipment is also generally capable of estimating the signal-to-noise ratio of a signal transmitted by the DSLAM.

In an embodiment of the method of the present invention, the crosstalk canceller comprises a precoder, the exchanging of the first signal comprises transmitting the first signal from the line termination equipment to the network termination equipment, and the error component is determined by the network termination equipment.

This embodiment implements the method of the present invention for use in the downstream channel.

In an embodiment of the method of the present invention, the crosstalk canceller comprises a postcoder, the exchanging of the second signal comprises transmitting the first signal from the network termination equipment to the line termination equipment, and the error component is determined by the line termination equipment.

This embodiment implements the method of the present invention for use in the upstream channel.

In an embodiment of the method of the present invention, the line termination equipment has a management interface for performing the configuring. In a particular embodiment, the management interface is adapted to receive an instruction to select the first set of crosstalk canceller parameters from among a group of pre-stored sets of crosstalk canceller parameters. In a particular embodiment, the management interface is adapted to receive an instruction specifying attenuation and crosstalk coupling coefficients constituting the first set of crosstalk canceller parameters.

It is an advantage of this embodiment that the test procedure of the present invention can be carried out with a variety of simulated coupled wireline networks, represented by different sets of crosstalk canceller parameters.

According to another aspect of the invention, there is provided a line termination apparatus suitable for testing a component of a vectoring system, the line termination apparatus being connectable to network termination equipment and comprising a crosstalk canceller adapted to be configured with a first set of crosstalk canceller parameters representing a simulated network, wherein the line termination equipment is configured to exchange a first signal with the line termination equipment, the first signal being coded by the crosstalk canceller; obtain information indicative of an error component in a received version of the first signal; and use the information to assess the operation of the component in the simulated network.

In an embodiment, the line termination apparatus of the present invention is configured to determine a second set of crosstalk canceller parameters in function of the information and to verify whether the second set of crosstalk canceller parameters substantially cancels the first set of crosstalk canceller parameters.

In an embodiment, the line termination apparatus of the present invention is configured to ascertain whether the second set of crosstalk canceller parameters is substantially a matrix-inverse of the first set of crosstalk canceller parameters.

In an embodiment of the line termination apparatus of the present invention, the crosstalk canceller is further adapted to be reconfigured with a third set of crosstalk canceller parameters, the line termination apparatus being further configured to calculate the third set of crosstalk canceller parameters as a function of the first set of crosstalk canceller parameters and the second set of crosstalk canceller parameters; reconfigure the crosstalk canceller with the third set of crosstalk canceller parameters; exchange a second signal with the line termination equipment, the second signal being coded by the crosstalk canceller; and obtain a detected error component of the coded second signal.

In an embodiment of the line termination apparatus of the present invention, the crosstalk canceller comprises a precoder, wherein the line termination equipment is configured to exchange the first signal by transmitting the first signal to the network termination equipment, and to obtain the information from the network termination equipment.

In an embodiment of the line termination apparatus of the present invention, the crosstalk canceller comprises a postcoder, wherein the line termination apparatus is configured to exchange the first signal by receiving the first signal from the network termination equipment, and to obtain the information by analyzing the received version of the first signal.

In an embodiment, the line termination apparatus of the present invention further comprises a management interface adapted to receive an instruction to select the first set of crosstalk canceller parameters from among a group of pre-stored sets of crosstalk canceller parameters.

In an embodiment, the line termination apparatus of the present invention further comprises a management interface adapted to receive an instruction specifying attenuation and crosstalk coupling coefficients constituting the first set of crosstalk canceller parameters.

According to another aspect of the present invention, there is provided a program for a processor of a piece of line termination equipment having a crosstalk canceller, comprising instructions to carry out the method disclosed above.

The advantages of the line termination apparatus and the program according to the present invention, and their various embodiments, are equivalent to those described above for the corresponding method.

### BRIEF DESCRIPTION OF THE FIGURES

Some embodiments of apparatus and/or methods in accordance with embodiments of the present invention are now described, by way of example only, and with reference to the accompanying drawings, in which:

FIG. 1 schematically illustrates a line termination apparatus according to the present invention;

FIG. 2 presents a flow chart of an embodiment of the method according to the present invention; and

FIG. 3 presents a flow chart of another embodiment of the method according to the present invention.

### DESCRIPTION OF EMBODIMENTS

In this application, precoders, used to cancel crosstalk in transmitted downstream signals (from the DSLAM to the subscriber side), and postcoders, used to cancel crosstalk in received upstream signals (from the subscriber side to the DSLAM), are collectively referred to as crosstalk cancellers. Where, in the following description, statements are made about “precoders” or “postcoders”, this is done without loss of generality, and these statements apply analogously to the respective counterpart, unless explicitly stated otherwise. Furthermore “exchanging” signals is intended to mean “receiving” or “transmitting” signals accordingly.

In a DSLAM with vectoring capabilities, the vectoring control entity (VCE) and the precoder are inherently multi-line systems. Testing of the functionalities of the VCE and precoder requires that crosstalk is present between the multiple lines. This cannot be performed by the known wireline simulators, even multi-line simulators, since they provide attenuation but do not deliberately introduce crosstalk between the lines. Test procedures of vectoring functionalities thus require a cable spool, and if multiple line lengths and gauges and so on are needed, an entire cable farm. Such real cable posed problems with repeatability of the tests: tests performed at vendor's premises may lead to different results as test performed at the customer's cable farm. Moreover, for acceptance without on-site testing, a significant measure of trust is derived from this repeatability.

The present invention is based inter alia on the insight that it is advantageous to provide a simulation of multiple coupled lines in the digital domain. It is further based on the insight that the precoder, available in every vectoring system, can advantageously be used as a crosstalk simulator.

One of the vectoring functionalities to be tested is crosstalk estimation algorithm (running in the VCE). This can be tested by setting the precoder coefficients such that a certain amount of crosstalk is introduced between the lines. These coefficients can be chosen randomly (based on statistics) or pre-defined (eg, the crosstalk channel matrix defined in the applicable standards). Also, direct channel coefficients may be set to mimic attenuation, or attenuation can be performed with known single-line simulators.

By making sure the crosstalk estimation algorithm is unaware of these coefficients, the functionality of the algorithm can be tested by letting it estimate the simulated channel, i.e., the set coefficients. The deviation from the coefficients is a measure of the accuracy of the VCE's algorithm.

In a normal crosstalk cancellation mode, the VCE would write the calculated coefficients into the precoder memory. This would destroy the ‘line simulating’ property of the VCE according to the invention. Hence, in the method of the invention, the calculated coefficients must either be read out and assessed independently, without moving to an operational stage of the vectoring function, or the VCE must be instructed to write cumulative coefficients into the precoder, consisting of the combined effect of the set of simulation coefficients and the set of calculated coefficients.

The signal-to-noise ratio or the error components of the signals that are transmitted from the DSLAM while the precoder is operating with these cumulative coefficients are metrics that may be used to assess the accuracy of the VCE's algorithm. In particular, a high signal-to-noise ratio, or a small error component, are indicative of a VCE that is operating well. Conversely, a low signal-to-noise ratio, or a large error component, are indicative of a VCE that is not operating well. When assessing signal-to-noise ratios or error components, due account should be taken of the contribution of the cabling and/or line simulators that connect the DSLAM to the network termination equipment.

Taking downstream as an example without loss of generality, on real cable, the vector of received signals y can be written as:

y=Hx+u (1)

Where x is the vector of transmitted signals and H is the channel matrix of the real cable. The diagonal elements represent the direct channel (attenuation and phase rotation) while the off-diagonal components represent crosstalk values (again, amplitude and phase). In a vectored system, a precoder is introduced in the DSLAM that pre-distorts the signals X such that the vector of received signals appears undistorted (except for external noise u):

y=HPx+u=x+u.

The goal of a multi-line simulator is to replace the real cable H by a simulate channel matrix Hsim. The present invention simulates H within the DSLAM by setting precoder coefficients: P=Hsim, where Hsim is a random or fixed matrix introduced for testing vectoring functionalities and includes off-diagonal elements, and may include diagonal elements with a magnitude smaller than one. In a further stage, the calculated precoder coefficients P′ are “added into” the precoder, wherein this addition may be a matrix multiplication, or, under the right approximating conditions, a matrix addition as expressed below:

y=Px+u=(Hsim+P′)x+u (2)

A function that may be tested according to the method of the invention is the VCE's ability to estimate Hsim, which is observable by the extent to which (Hsim+P′) approaches 1. Similarly, joining and leaving events, and tracking can be tested.

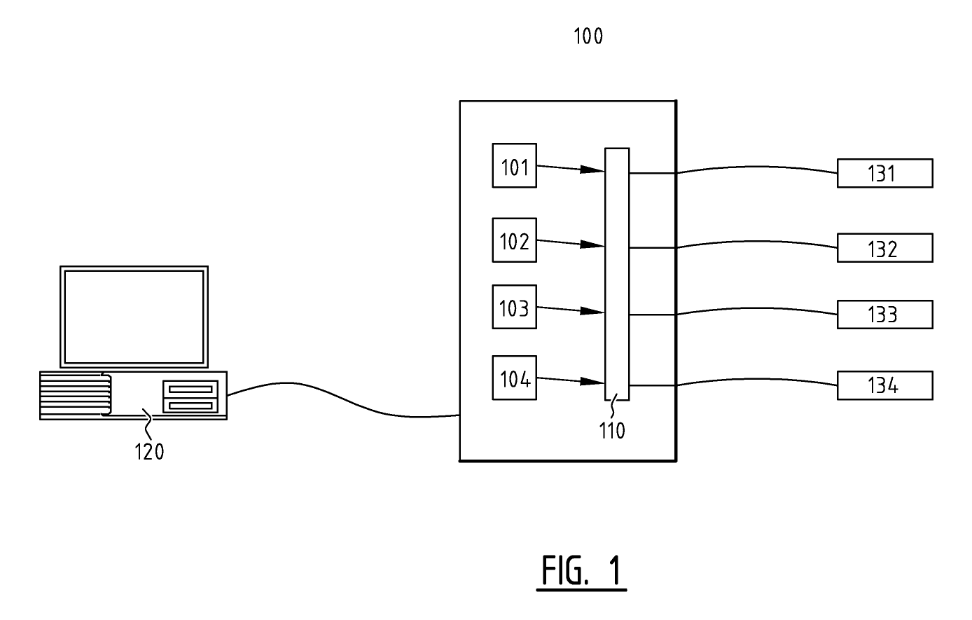

FIG. 1 schematically illustrates a DSLAM 100, comprising a precoder 110, fed by four digital signal processors 101-104, representing four digital subscriber lines. Four pieces of network termination equipment, preferably customer premises equipment 131-134, are attached to ports of DSLAM 100, by means of wires that preferably have extremely low attenuation. Optionally, a wireline simulator may be provided between DSLAM 100 and each of the pieces of customer premises equipment 131-134. It shall be noted that the number of subscriber lines and DSLAM ports is arbitrarily chosen as four, for clarity of the figure, and shall not be considered to impose any limitation on the invention as claimed.

The DSLAM 100 further presents a management interface, to which a management station 120 is attached. In the set-up of FIG. 1, operating in downstream vectoring mode, the precoder 110 receives signals, in particular sequences of constellations from each of the digital signal processors 101-104, and mixes these signals by adding a scaled component of each of the various signals to each of the other signals, whereupon the vectored signals are transmitted through the ports of DSLAM 100.

It is understood that in the known DSLAMs the precoder 110 will start out in a mode that introduces substantially no mixing between the various signals, and will then assess the error components reported by the customer premises equipment 131-134, to estimate the cross-talk characteristics of the wireline network, and to update the precoder coefficients so as to minimize the perceived cross-talk at the receiving end. In the operation of the known vectoring DSLAMs, this happens without intervention from a management agent. In embodiments of the DSLAM of the present invention, a management station 120 is used to program precoder 110 with the predetermined simulation parameters, and to take the necessary steps to either read out the calculated precoder coefficients resulting from the simulation set-up, or to continue into a modified vectoring mode in which the precoder is reprogrammed with a combined set of precoder coefficients, derived from both the original simulation set and the calculated set. A testing procedure can be carried out according to the methods as described above.

It shall be understood that the DSLAM 100 of FIG. 1 may additionally or alternatively comprise a postcoder, for performing crosstalk cancellation in the upstream path. The resulting DSLAM presents the same structure as the one described before, and may be clarified by means of the same FIG. 1. DSLAM 100 comprises a postcoder 110, feeding into four digital signal processors 101-104, representing four digital subscriber lines. Four pieces of network termination equipment, preferably customer premises equipment 131-134, are attached to ports of DSLAM 100, by means of wires that preferably have extremely low attenuation. Optionally, a wireline simulator may be provided between DSLAM 100 and each of the pieces of customer premises equipment 131-134.

In the set-up of FIG. 1, operating in upstream vectoring mode, the precoder 110 receives signals, in particular sequences of constellations from each of the subscriber lines to which customer premises equipment 131-134 are attached, and unmixes these signals by adding a scaled component of each of the various signals to each of the other signals, whereupon the vectored signals are provided to the digital signal processors 101-104. The DSLAM 100 is capable of determining an error component in the signal received from the postcoder 110.

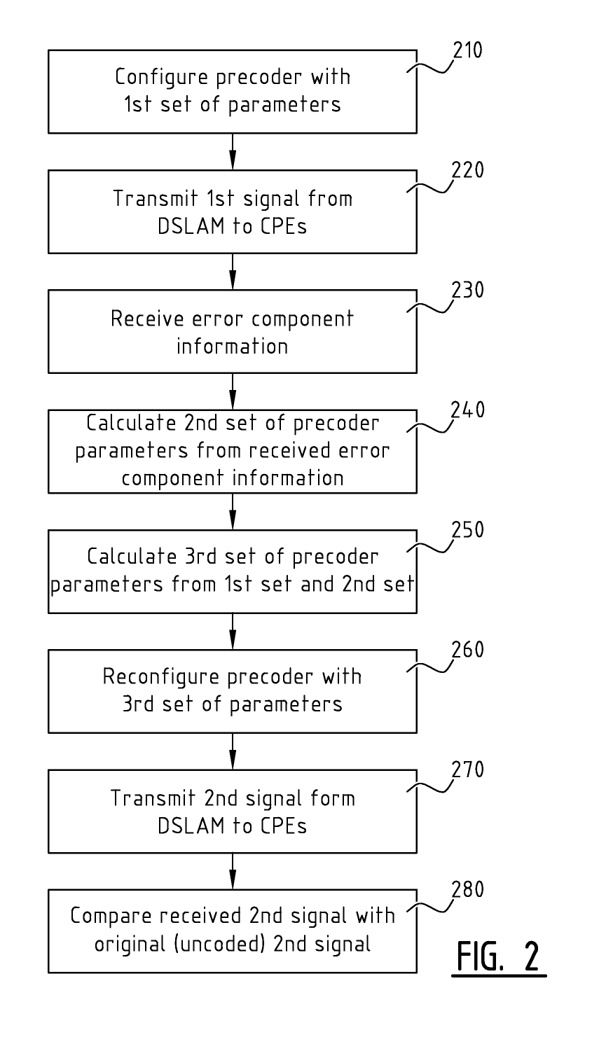

FIG. 2 provides a flow chart of an embodiment of the method of the present invention. In a first step 210 the precoder 110 is configured with a first step of parameters, which represent s certain multiline network with crosstalk coupling between the various lines. Considering the precoder coefficients as a matrix, such coupling between the lines is represented by non-zero values in off-diagonal positions of the matrix. Obviously, the values of the various coefficients of the matrix may be chosen so as to also represent a certain amount of attenuation and/or phase distortion.

The configuration of the precoder 110 preferably takes place by a management agent 120 via an appropriate management interface. As the precoder coefficients to be used in standardized tests will typically be identical to those published in testing standards, it is advantageous to provide a management interface that allows selecting a given preprogrammed set of precoder coefficients for the test to be carried out. Alternatively or additionally, the management interface may allow inputting the actual precoder coefficient values to allow additional tests, in particular customized tests, to address particular operational situations. Typically, the management interface will also allow selecting the lines of the DSLAM 100 on which the test is to be run.

Next, the VCE of DSLAM 100 will be allowed to carry out its algorithm for estimating the cross-talk channel, and for calculating the appropriate precoder coefficients that cancel the estimated cross-talk to the best possible extent. To perform these functions, the VCE will first cause the DSLAM 100 to transmit a first signal though the precoder to the attached network terminating equipment 131-134 in step 220. The attached network terminating equipment 131-134 may advantageously be standardized customer premises equipment, which is capable of determining an error component in a received signal, in particular a pilot signal. The customer premises equipment 131-134 is also capable of estimating the signal to noise ratio in a received signal. Having measured this error component, the customer premises equipment will inform the DSLAM 100 of its measurement, typically by means of a dedicated management message, in step 230. The error components so received from the different pieces of customer premises equipment 131-134 on the different respective lines, will allow the VCE to estimate the cross-talk channel. On the basis of this information, the VCE will calculate in step 240 a second set of precoder parameters, which is the set that would be adopted to cancel the cross-talk in a network as simulated by the first set.

In order to assess the quality of the overall vectoring system, or sub-functionalities thereof such as the VCE's algorithm, it is now necessary to determine the adequacy of the second set of precoder parameters. This may be done by reading out the calculated precoder parameters from the DSLAM 100 via an appropriate management interface and comparing them to the first set of precoder parameters that was used for the simulation. In particular, the comparison should be carried out so as to reveal whether the calculated set would adequately cancel the cross-talk represented by the simulation set. In terms of matrices, the matrix of the first set of precoder coefficients and the matrix of the second set of precoder coefficients should substantially be each other's inverse, i.e., they should result in a unity matrix after matrix multiplication. Unintentional crosstalk in the path between precoder and CPE, such as through cabling, may determine the extent to which the matrix multiplication results in a unity matrix.

A person skilled in the art will appreciate that various metrics may be used to quantify the amount in which the calculated set of parameters deviates from the matrix that would allow perfect cross-talk cancelation.

As an alternative to extracting the calculated parameter set from the DSLAM 100 and applying a comparison to it, it is advantageous to let the DSLAM 100 operate in a normal vectoring mode, using a set of precoder coefficients that is a combination of the first set of coefficients and the second set of coefficients. When the precoder 110 operates using this third set of coefficients, it effectively acts at once as a multiline wireline simulator and as a cross-talk cancelation engine. In the ideal case, the resulting signals transmitted by the DSLAM 100 through the precoder 110, should be completely free from cross-talk.

The extent to which the precoder approaches this ideal case, may be assessed by transmitting a second signal from the DSLAM 100 to the attached network termination equipment 131-134 in step 270, and by determining an error component in the signal received at the network termination equipment 131-134 in step 280. The extent to which the precoder approaches the ideal case may be quantified by comparing performance metrics of a line in step 270-280 with the performance metrics of that line when no other lines are active, and hence no crosstalk is present.

As indicated before, standardized customer premises equipment may be used to terminate the network, which has the advantage that this equipment's ability to detect an error component, or to estimate a signal to noise ratio, may be used to assess the quality of the coded signal. As can be understood, a signal received at the customer premises equipment with a very small error component or a corresponding high signal to noise ratio, will be indicative of a good operation of the precoding engine, while a signal received at the customer premises equipment, with a large error component or a correspondingly low signal to noise ratio, will be indicative of less good operation of the vectoring engine.

Hence, the method of the present invention provides a way to use a DSLAM in a partial self-test mode, to determine the proper operation of the vectoring functions in that DSLAM.

Alternatively or additionally, the method described above may be used for testing the functionalities of standardized customer premises equipment or the interoperability of standardized customer premises equipment with the DSLAM. Apart from functional tests, the method described above can also be used for performance tests.

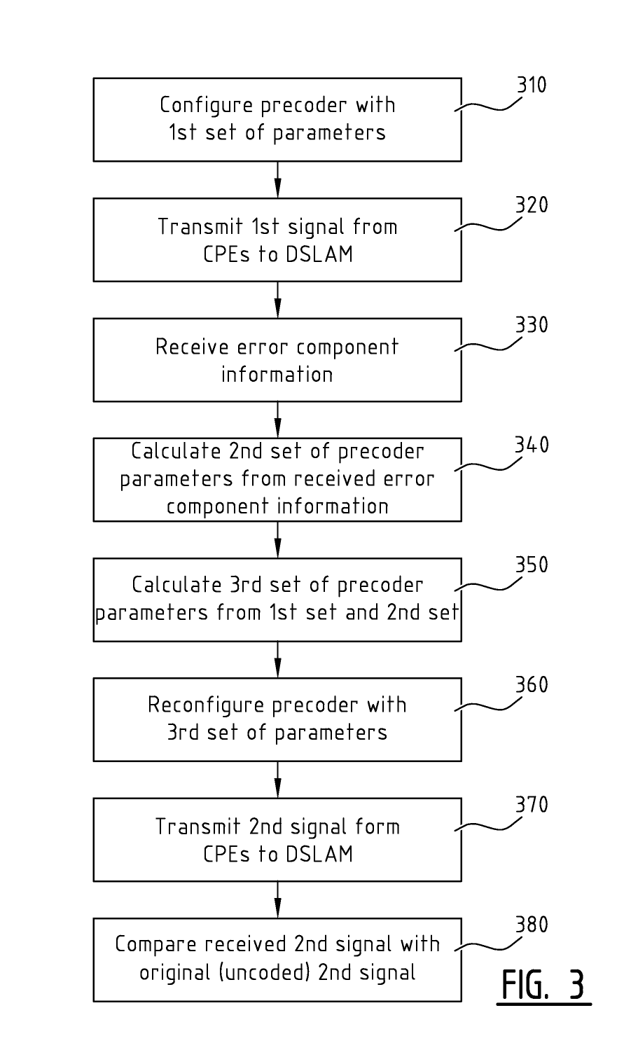

The method described above may also be used for testing a vectoring algorithm applied to upstream signals. FIG. 3 provides a flowchart of an embodiment of the method according to the present invention, applied to upstream signals. The method is carried out in an analogous manner as for vectoring applied to downstream signals; specific details described above in the context of FIG. 2 may be applied to the method of FIG. 3 and will not be repeated here.

The postcoder 110 is initially programmed in step 310 with a first set of postcoder parameters, which represent a network topology with a certain amount of crosstalk. A first set of signals, preferably pilot signals, is transmitted from the network termination equipment 131-134 to the DSLAM 100 in step 320. Error component information is determined at the DSLAM in step 330, and a second set of postcoder parameters is calculated on the basis of that information in step 340. The second, calculated set of postcoder parameters may be assessed as such, as described before, or it may be merged into the postcoder 110 by calculating a third set of precoder parameters on the basis of the first and the second sets, in step 350. The postcoder 110 is then reconfigured with the third set of parameters. A second set of signals, preferably pilot signals, is transmitted from the network termination equipment 131-134 to the DSLAM 100 in step 370. On the basis of the received version of the second set of signals, which has passed through the postcoder 110, the quality of the postcoder operation can be judged. In particular, the received version of the second set of signals is compared to the expected or original version of these signals in step 380. This comparing may consist of determining an error component or a signal-to-noise ratio.

Embodiments of the present invention relate to line termination apparatus, such as DSLAMs, line termination cards, or sets of line termination cards, configured to carry out the relevant steps of the methods described above. A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

1. A method for testing a component of a vectoring system, said vectoring system comprising line termination equipment having a crosstalk canceller and network termination equipment attached to said line termination equipment, the method comprising:
configuring said crosstalk canceller with a first set of crosstalk canceller parameters representing a simulated network;
exchanging a first signal between said line termination equipment and said network termination equipment, said first signal being coded by said crosstalk canceller;
obtaining at said line termination equipment information indicative of an error component in a received version of said first signal; and
using said information to assess the operation of said component in said simulated network.

2. The method of claim 1, wherein said using of said information comprises:
determining at said line termination equipment a second set of crosstalk canceller parameter in function of said information; and
verifying whether said second set of crosstalk canceller parameters substantially cancels said first set of crosstalk canceller parameters.

3. The method of claim 2, wherein said verifying comprises obtaining said second set of crosstalk canceller parameters from said line termination equipment, and ascertaining whether said second set of crosstalk canceller parameters is substantially a matrix-inverse of said first set of crosstalk canceller parameters.

4. The method of claim 2, wherein said verifying comprises:
calculating a third set of crosstalk canceller parameters as a function of said first set of crosstalk canceller parameters and said second set of crosstalk canceller parameters;
reconfiguring said crosstalk canceller with said third set of crosstalk canceller parameters; exchanging a second signal between said line termination equipment and said network termination equipment, said second signal being coded by said crosstalk canceller; and
detecting an error component of said coded second signal.

5. The method of claim 1, wherein said crosstalk canceller comprises a precoder, wherein said exchanging of said first signal comprises transmitting said first signal from said line termination equipment to said network termination equipment, and wherein said error component is determined by said network termination equipment.

6. The method of claim 1, wherein said crosstalk canceller comprises a postcoder, wherein said exchanging of said first signal comprises transmitting said first signal from said network termination equipment to said line termination equipment, and wherein said error component is determined by said line termination equipment.

7. The method of claim 1, wherein said line termination equipment has a management interface for performing said configuring, said management interface being adapted to receive an instruction to select said first set of crosstalk canceller parameters from among a group of pre-stored sets of crosstalk canceller parameters.

8. The method of claim 1, wherein said line termination equipment has a management interface for performing said configuring, said management interface being adapted to receive an instruction specifying attenuation and crosstalk coupling coefficients constituting said first set of crosstalk canceller parameters.

9. A line termination apparatus suitable for testing a component of a vectoring system, said line termination apparatus being connectable to network termination equipment and comprising a crosstalk canceller adapted to be configured with a first set of crosstalk canceller parameters representing a simulated network, wherein said line termination equipment is configured to:
exchange a first signal with said line termination equipment, said first signal being coded by said crosstalk canceller;
obtain information indicative of an error component in a received version of said first signal; and
use said information to assess the operation of said component in said simulated network.

10. The line termination apparatus of claim 9, configured to determine a second set of crosstalk canceller parameters in function of said information and to verify whether said second set of crosstalk canceller parameters substantially cancels said first set of crosstalk canceller parameters.

11. The line termination apparatus of claim 10, configured to ascertain whether said second set of crosstalk canceller parameters is substantially a matrix-inverse of said first set of crosstalk canceller parameters.

12. The line termination apparatus of claim 10, wherein said crosstalk canceller is further adapted to be reconfigured with a third set of crosstalk canceller parameters, said line termination apparatus being further configured to:
calculate said third set of crosstalk canceller parameters as a function of said first set of crosstalk canceller parameters and said second set of crosstalk canceller parameters;
reconfigure said crosstalk canceller with said third set of crosstalk canceller parameters;
exchange a second signal with said line termination equipment, said second signal being coded by said crosstalk canceller; and
obtain a detected error component of said coded second signal.

13. The line termination apparatus of claim 9, wherein said crosstalk canceller comprises a precoder, wherein said line termination equipment is configured to exchange said first signal by transmitting said first signal to said network termination equipment, and to obtain said information from said network termination equipment.

14. The line termination apparatus of claim 9, wherein said crosstalk canceller comprises a postcoder, wherein said line termination apparatus is configured to exchange said first signal by receiving said first signal from said network termination equipment, and to obtain said information by analyzing said received version of said first signal.

15. The line termination apparatus of claim 9, further comprising a management interface adapted to receive an instruction to select said first set of crosstalk canceller parameters from among a group of pre-stored sets of crosstalk canceller parameters.

16. The line termination apparatus of claim 9, further comprising a management interface adapted to receive an instruction specifying attenuation and crosstalk coupling coefficients constituting said first set of crosstalk canceller parameters.

17. A program for a processor of a piece of line termination equipment having a crosstalk canceller, the program comprising instructions to carry out the method of claim 1.
